(19) United States
(12) Patent Application Publication
(10) Pub. No.: US 2026/0105651 A1
(43) Pub. Date: Apr. 16, 2026

(54) GENERATING VECTORIAL PATTERNS WITH SPARSITY CONTROL

(71) Applicant: ADOBE INC., SAN JOSE, CA (US)

(72) Inventors: Adrian-Stefan Ungureanu-Contes, Bucharest (RO); Vlad-Constantin Lungu-Stan, Bucharest (RO); Marian Lupascu, Bucharest (RO); Ionut Mironica, Bucharest (RO)

(21) Appl. No.: 18/916,349

(22) Filed: Oct. 15, 2024

(51) Int. Cl. G06T 11/00; G06F 40/40

(52) U.S. Cl. CPC G06T 11/10; G06F 40/40

(57) ABSTRACT

A method, apparatus, non-transitory computer readable medium, and system for generating pattern images with controllable density includes obtaining an input prompt that indicates an image element and a sparsity level. An image generation prior model encodes the input prompt to obtain a prior embedding that represents the image element and the sparsity level. An image generation model generates a synthetic image based on the prior embedding. The synthetic image depicts a pattern including the image element and the sparsity level.

### BACKGROUND

The following relates generally to image processing, and more specifically to vector pattern data generation. Image processing is a type of data processing that involves the manipulation of an image to get the desired output, typically utilizing specialized algorithms and techniques. Image processing is used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Pattern images are images that can be stitched together in a process known as “tiling” to provide backgrounds and design elements. Images that can be stitched together seamlessly are sometimes referred to as “tile-able images.” In some cases, image generation models can struggle to produce repeatable patterns or to generate images with a sufficient quantity of image elements.

### SUMMARY

Embodiments of the present inventive concepts described herein include systems and methods for generating pattern images with a controllable density level of image elements. Embodiments enable a user to provide a text prompt describing the image element, as well as a sparsity input that indicates a desired level of density (also referred to herein as “crowdedness”). Embodiments then process the text prompt and the sparsity input to obtain a prior embedding that represents the image element and the sparsity concepts in an image embedding space. Embodiments use the prior embedding to condition the generative process of an image generation model to obtain a synthetic image depicting a pattern of the image element with the desired level of density.

A method, apparatus, non-transitory computer readable medium, and system for pattern image generation are described. One or more aspects of the method, apparatus, non-transitory computer readable medium, and system include obtaining an input prompt that indicates an image element and a sparsity level; encoding, using an image generation prior model, the input prompt to obtain a prior embedding that represents the image element and the sparsity level; and generating, using an image generation model, a synthetic image based on the prior embedding, wherein the synthetic image depicts a pattern including the image element and the sparsity level.

A method, apparatus, non-transitory computer readable medium, and system for pattern image generation are described. One or more aspects of the method, apparatus, non-transitory computer readable medium, and system include obtaining training data including an image and a training prompt that indicates an image element; classifying the image using a sparsity classifier to obtain a sparsity level; generating a predicted prior embedding based on the training prompt and the sparsity level; and training, using the training data, an image generation prior model to generate a prior embedding that represents the image element and a pattern with the sparsity level.

An apparatus, system, and method for pattern image generation are described. One or more aspects of the apparatus, system, and method include at least one processor; at least one memory storing instructions executable by the at least one processor; an image generation prior model storing parameters in the at least one memory and trained to encode an input prompt to obtain a prior embedding that represents an image element and a sparsity level; and an image generation model storing parameters in the at least one memory configured to generate a synthetic image based on the prior embedding, wherein the synthetic image depicts a pattern including the image element and the sparsity level.

### BRIEF DESCRIPTION OF THE DRAWINGS

FIG. 1 shows an example of a pattern generation system according to aspects of the present disclosure.

FIG. 2 shows an example of a pattern generation apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of a generation pipeline according to aspects of the present disclosure.

FIG. 6 shows an example of a method a reverse diffusion process according to aspects of the present disclosure.

FIG. 7 shows an example of a method for providing a pattern image with a desired level of crowdedness to a user according to aspects of the present disclosure.

FIG. 8 shows an example of a method for generating a pattern image according to aspects of the present disclosure.

FIG. 9 shows an example of a training data preparation pipeline according to aspects of the present disclosure.

FIG. 10 shows an example of an image generation prior model training pipeline according to aspects of the present disclosure.

FIG. 11 shows an example of a machine learning ML (model) training algorithm according to aspects of the present disclosure.

FIG. 12 shows an example of a method a diffusion training process according to aspects of the present disclosure.

FIG. 13 shows an example of a method for training a machine learning model according to aspects of the present disclosure.

FIG. 14 shows an example of a training pipeline for learning color conditioning according to aspects of the present disclosure.

FIG. 15 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Pattern data includes images that can be stitched together in a process known as “tiling” to provide backgrounds and design elements. As used herein, a “tile-able pattern” is an image that can be repeated seamlessly to fit an area. “Vector” pattern data typically refers to the underlying representation of the image, a vector image format. A vector image format refers to a type of digital graphic representation that utilizes mathematical equations to define paths and shapes, rather than mapping individual pixels, facilitating scalable and resolution-independent rendering of the image elements. This format allows for precise manipulation of image attributes such as colors, shapes, and outlines without degradation in quality, making it a preferred format for logos and illustrations. In some cases, the term “vector” also represents a style of images, which while represented in the pixel space, include “vectorizable” attributes such as flat colors, distinct shapes, and clean lines.

Pattern “density” refers to the arrangement and spacing of components within a pattern. It is a measure of how many visual elements are present in a given area and how closely they are arranged. A pattern with a high density contains many elements packed tightly together, whereas a pattern with low density features fewer elements spaced farther apart. Control over pattern density is important for design flexibility, as it allows creators to adjust the visual impact of the pattern according to the desired application. For example, densely packed patterns may be suitable for textile designs or wallpapers, whereas sparser patterns might be preferred for branding elements or minimalist designs where clarity and focus are important. Additionally, pattern density can encompass not only the number of elements but also their size in relation to one another, which contributes to the overall clutter or spaciousness of a pattern.

Some approaches to pattern generation involve using machine learning models to automatically generate repeating elements based on user input or pre-defined rules. These models may leverage techniques that allow patterns to be generated seamlessly, ensuring that the pattern can be tiled without visible breaks. However, these approaches do not provide granular control over the final pattern such as density or element scaling. For example, simply adjusting the size of the pattern elements uniformly may not be sufficient, as users may wish to control the size of some elements independently of others. Additionally, some techniques generate patterns by creating individual elements and stitching them together. While this can offer flexibility, it is either computationally expensive or requires significant manual work and can be prone to errors especially when the elements need to align perfectly to be tileable.

Embodiments of the present disclosure improve the accuracy of image generation systems by enabling density control in generated pattern images. Embodiments include a text encoder configured to obtain tokens from a text prompt and a sparsity input and process the combined tokens to obtain a text embedding. An image generation prior model generates an image embedding—referred to as a prior embedding—from the text embedding. The image embedding is generated within a multimodal space, allowing for translation between different types of input modalities. In some cases, the multimodal space may correspond to the CLIP embedding space, where both text and image embeddings are represented. The prior embedding encodes the visual aspects the user indicated sparsity, as well as of the image element described in the text prompt. An image generation model then generates an image using the prior embedding as conditioning. The generated image depicts a pattern of the image element with the desired sparsity level.

Embodiments also include a training process that configures the image generation prior model to generate embeddings that accurately reflect the concept of “sparsity.” During training, the model compares its predicted image embedding to a ground-truth embedding from a training image with a known sparsity level. Since the predicted image embedding is generated from a text embedding that includes a sparsity token representing the level of sparsity, the model gradually learns to interpret this text embedding to accurately convey the correct sparsity level in the image. Additionally, the training process updates the values of “nonce tokens” (i.e., unused tokens in the token vocabulary) to encode representations for different levels of density.

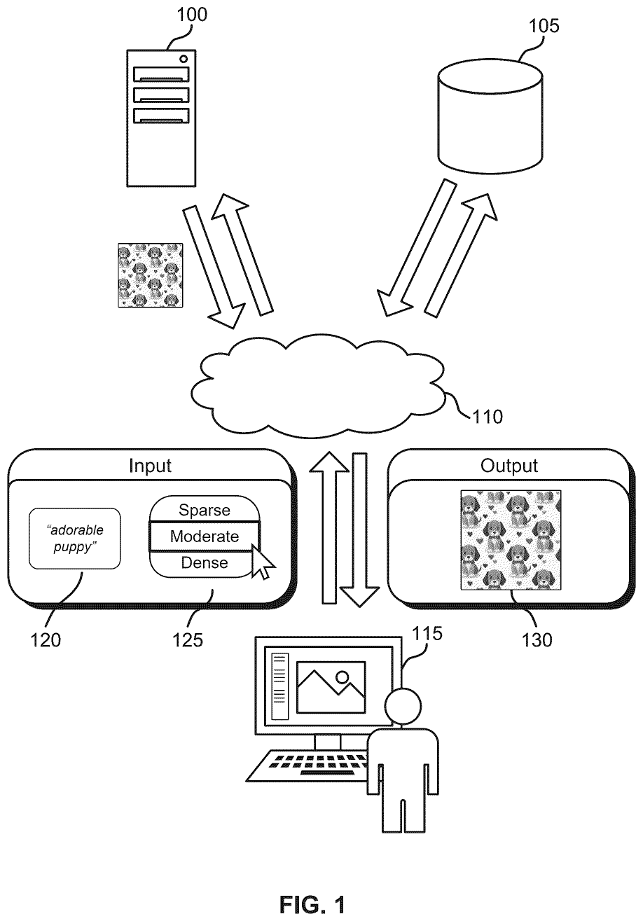

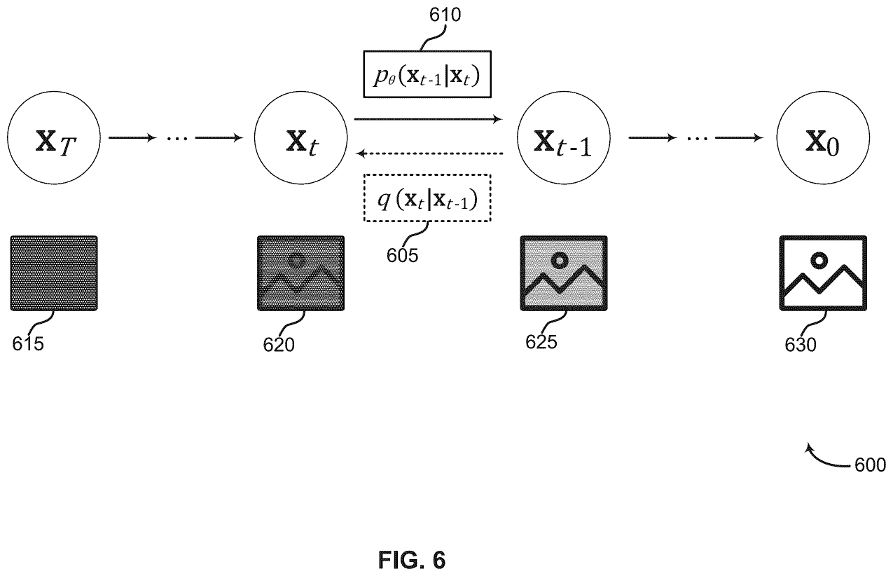

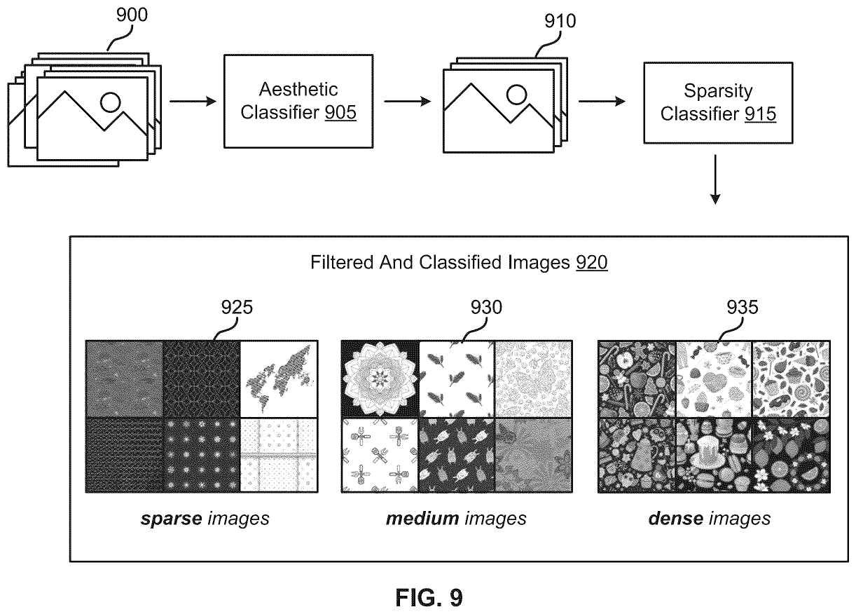

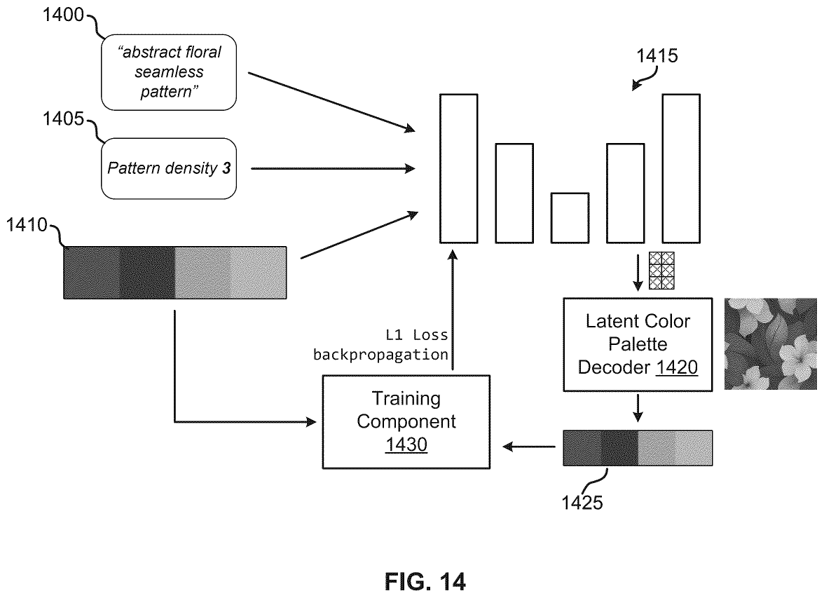

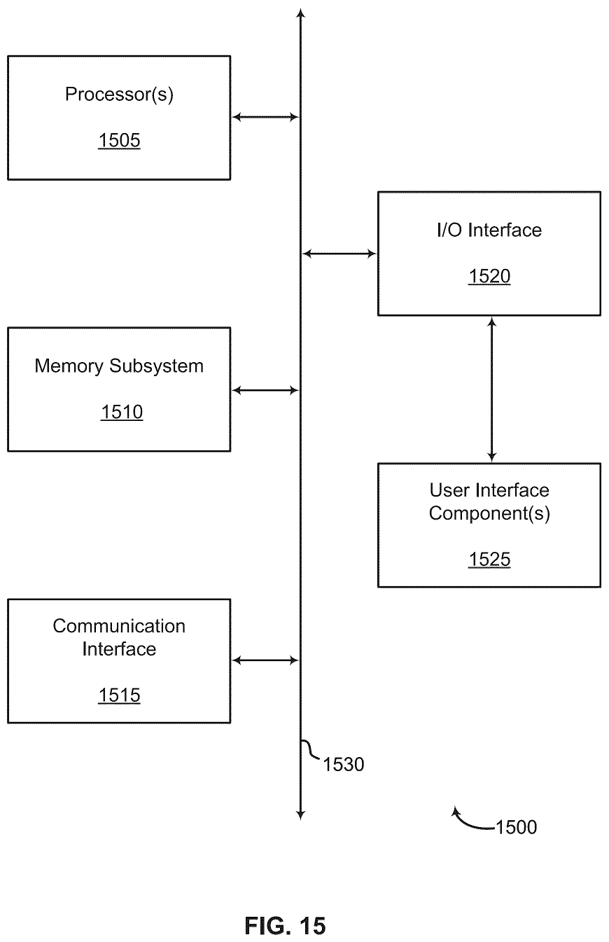

A pattern generation system is described with reference to FIGS. 1-5. Methods for generating pattern images with controllable density are described with reference to FIGS. 6-8. Training methods for configuring an image generation prior model and for learning sparsity token embedding values (token “definitions”) are described with reference to FIGS. 9-13. A training scheme for training an image generation model to generate images with a particular color palette is described with reference to FIG. 14. A computing device configured to implement a pattern generation apparatus is described with reference to FIG. 15.

### Pattern Generation System

FIG. 1 shows an example of a pattern generation system according to aspects of the present disclosure. The example shown includes pattern generation apparatus 100, database 105, network 110, user interface 115, text prompt 120, sparsity input 125, and pattern image 130.

In an example, a user provides an input including text prompt 120 and sparsity input 125. The text prompt 120 describes an image element to include in the generated pattern, and the sparsity input 125 indicates a desired density level of the image element in the final generated pattern, also sometimes referred to as a level of “crowdedness.” In this example, there are three sparsity levels to choose from, “sparse” being the least dense, and “dense” being the most dense. The image generation model 100 then processes the inputs to generate a pattern image 130 depicting the image element (in this example, a puppy) with a density corresponding to the sparsity input 125. In at least some embodiments, the sparsity input 125 may be extracted from the text prompt 120 by utilizing, for example, a large language model. The text prompt is also referred to as a “content prompt” herein.

In some embodiments, pattern generation apparatus 100 may be implemented in whole or in part on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

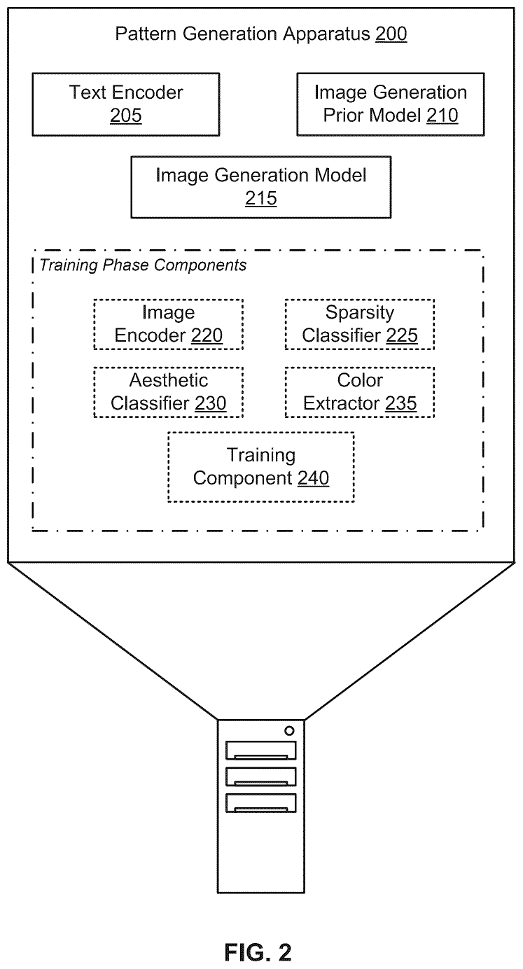

According to some aspects, pattern generation apparatus 100 obtains an input prompt that indicates an image element and a sparsity level. In some examples, pattern generation apparatus 100 obtains a content prompt and a sparsity indicator. In some examples, pattern generation apparatus 100 obtains a color input indicating one or more colors, where the synthetic image is generated based on the color input to include the one or more colors. Pattern generation apparatus 100 is an example of, or includes aspects of, the corresponding element described with reference to FIG. 2.

Database 105 stores information used by the pattern generation system, such as stock images, synthesized patterns, model parameters, configuration files, instructions executable by the pattern generation apparatus 100, and the like. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, a user interacts with a database controller. In other cases, the database controller may operate automatically without user interaction.

Network 110 is used to facilitate the transfer of information between pattern generation apparatus 100, database 105, and a user, e.g. via user interface 115. The network 110 is sometimes referred to as the “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with a device. In some embodiments, user interface 115 includes an audio device, such as an external speaker system, an external display device such as a display screen, or an input device (e.g., remote control device interfaced with user interface 115 directly or through an IO controller module). In some cases, user interface 115 includes a graphical user interface (GUI).

FIG. 2 shows an example of a pattern generation apparatus 200 according to aspects of the present disclosure. The example shown includes pattern generation apparatus 200, text encoder 205, image generation prior model 210, image generation model 215, image encoder 220, sparsity classifier 225, aesthetic classifier 230, color extractor 235, and training component 240.

The pattern generation apparatus 200 described herein may include several components. These components are variously named and are described so as to partition the functionality enabled by the processor(s) and the executable instructions included in the computing devices used to implement the apparatuses (such as the computing device described with reference to FIG. 15). In some examples, the partitions are implemented physically, such as through the use of separate circuits or processors for each component. In some examples, the partitions are implemented logically via the architecture of the code executable by the processors. Pattern generation apparatus 200 is an example of, or includes aspects of, the corresponding element described with reference to FIG. 1.

Some components of the pattern generation apparatus may be implemented with an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Text encoder 205 is configured to generate a text embedding from an input text. The text encoder 205 may include a tokenizer, which processes an input text to obtain a sequence of tokens. The text encoder 205 may further be configured to translate a user's sparsity input into a token representing the level of sparsity. For example, if the system is configured to distinguish between 3 levels of sparsity, the text encoder 205 may choose 1 of 3 available nonce tokens that correspond to the user's sparsity input. The text encoder 205 may then append this chosen token to the text tokens and encode this token sequence to obtain a text embedding. The encoding process may entail looking up initial token embeddings using token identifiers and processing these embeddings through transformer layers, which adjust the embeddings to encode context based on the surrounding tokens. This context-aware text embedding can then be processed by the image generation prior model 210 to obtain an image embedding. The image embedding can be used to condition image generation model 215, guiding the generation of a pattern image with the desired level of density.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Image generation prior model 210 is trained to generate an image embedding from an input text embedding. The image embedding is generated within a multimodal space, which allows both text and image data to be represented in a shared space. This enables the model to translate the semantic meaning of the text embedding into a visual representation. For example, in some embodiments, the multimodal space may correspond to the CLIP embedding space, where both text and image embeddings are aligned to capture their corresponding meanings. This translation ensures that the content described in the text can be effectively mirrored in the generated image. Embodiments of image generation prior model 210 include a guided latent diffusion model.

Image generation model 215 is configured to generate synthetic images. The image generation model 215 may generate synthetic images based on an external condition, such as the prior embedding described above, a text embedding, or both. Embodiments of image generation model 215 include a guided latent diffusion model. In some cases, image generation model 215 is based on a diffusion-matching distillation (DMD) model, which approximates the multi-iteration generative process of a traditional diffusion model into a single generative iteration.

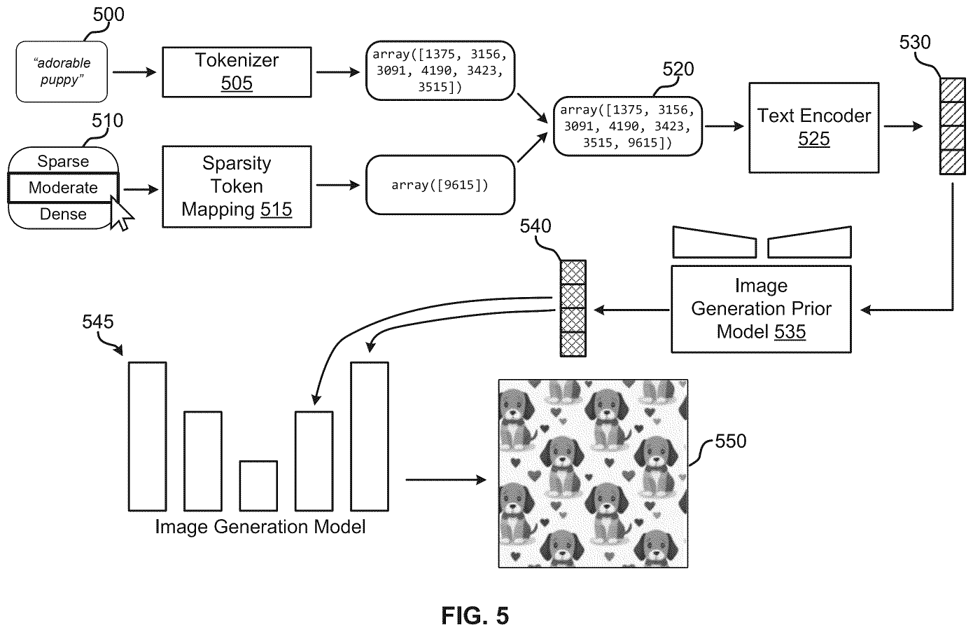

According to some aspects, image generation model 215 generates a synthetic image based on the prior embedding, where the synthetic image depicts a pattern including the image element and the sparsity level. In some examples, image generation model 215 obtains a noise input. The noise input may be, for example, a noise map tensor in a pixel space or a latent space. In some examples, image generation model 215 denoises the noise input based on the prior embedding to obtain the synthetic image. In some aspects, the image generation model 215 is trained using training data including a training prompt that indicates the sparsity level. Image generation model 215 is an example of, or includes aspects of, the corresponding element described with reference to FIGS. 5 and 14.

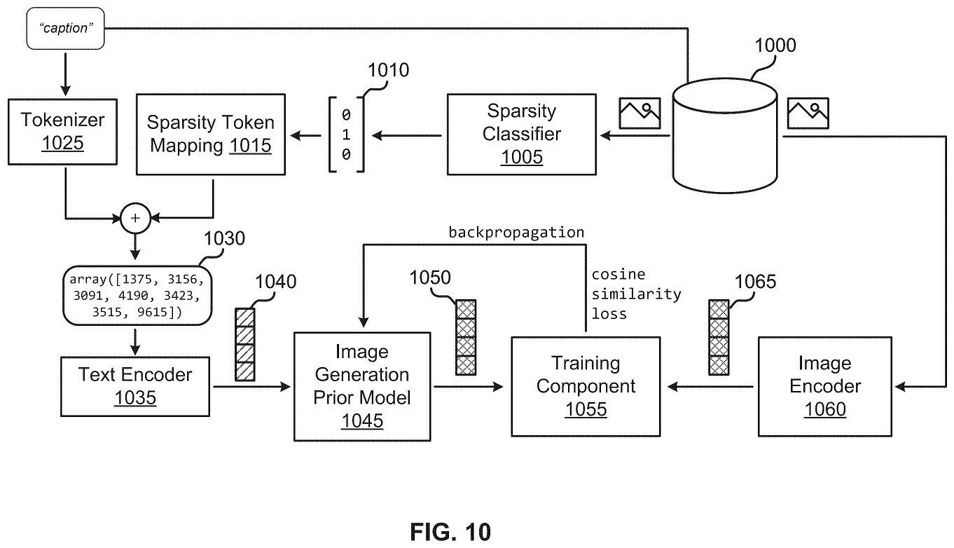

The pattern generation apparatus 200 includes components such as image encoder 220, sparsity classifier 225, aesthetic classifier 230, color extractor 235, and training component 240 that are used during one or more training phase(s) to train the image generation prior model 210 and the image generation model 215. They will be described in greater detail with reference to FIGS. 9-10. In at least one embodiment, one or more of these components are implemented on an apparatus that's different from pattern generation apparatus 200.

The image encoder 220 is used to generate a ground-truth image embedding from an input image for use in training the image generation prior model 210. Embodiments of the image encoder 210 include, but are not limited to, a vision transformer encoder such as the CLIP image encoder. Sparsity classifier 225 processes an input image to classify its sparsity level. Embodiments of sparsity classifier include a multi-layer perceptron (MLP) configured to output a 1-hot vector that indicates the sparsity level. The sparsity classifier is used to determine which sparsity token should be appended to the text tokens obtained from the caption of a training image.

A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships.

Aesthetic classifier 230 processes an input image to generate an aesthetic score, which indicates a probability of desirable visual features. The aesthetic classifier 230 may be biased towards “vector-like” data, which has the vectorizable attributes described above. It is used to filter a larger dataset by removing un-aesthetic images. Color extractor 235 processes a latent code from image generation model 215 to obtain a color palette of the current sample. This obtained color palette is compared to an input color palette, and an L1 loss that quantifies the differences between the two color palettes is used to train image generation model 215 to adhere to a color condition.

Training component 240 is configured to update parameters of image generation prior model 210 and image generation model 215 during one or more training phases. According to some aspects, training component 240 trains, using training data, an image generation prior model 210 to generate a prior embedding that represents the image element and a pattern with the sparsity level. In some examples, training component 240 computes a similarity between the predicted prior embedding and the image embedding. In some examples, training component 240 updates parameters of the image generation prior model 210 based on the similarity. Training component 240 is an example of, or includes aspects of, the corresponding element described with reference to FIGS. 10 and 14.

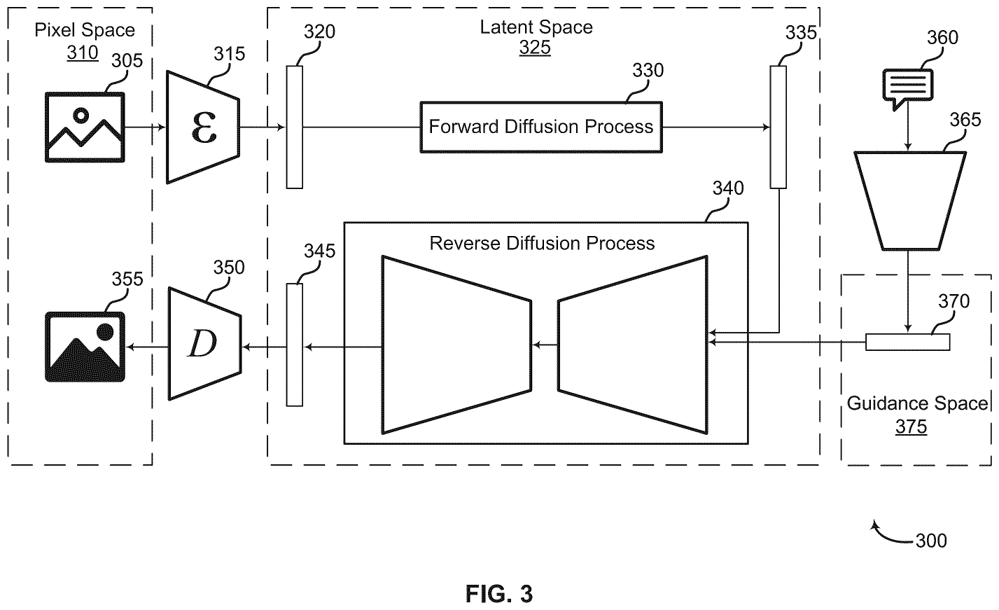

FIG. 3 shows an example of a guided latent diffusion model 300 according to aspects of the present disclosure. The guided latent diffusion model 300 depicted in FIG. 3 is an example of, or includes aspects of, the image generation prior model 210 and the image generation model 215 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. The process may be repeated to generate frames of a video or may be carried out on a spectrogram data and passed through a vocoder to generate sound. According to some aspects, diffusion models that are used to generate videos and/or sound may include additional architectural adaptations, such as temporal layers that ensure coherency between frames or waveforms.

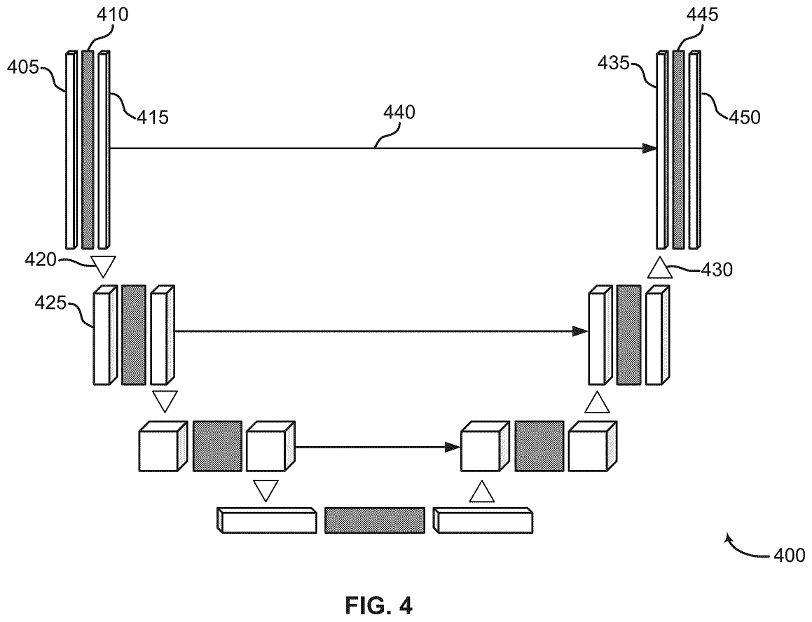

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the image generation prior model 210 and the image generation model 215 described with reference to FIG. 2.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415. Embodiments of the image generation model described herein may combine anchor features in a similar manner, but instead of adding the influence of the anchor features, embodiments may subtract the influence. This can be achieved by computing attention weights for the anchor features and then subtracting the resulting weighted features from the intermediate features 415. By doing so, the model reduces the presence of elements associated with the anchor features in the generated output.

FIG. 5 shows an example of a generation pipeline according to aspects of the present disclosure. The example shown includes text prompt 500, tokenizer 505, sparsity input 510, sparsity token mapping 515, combined text and sparsity tokens 520, text encoder 525, text embedding 530, image generation prior model 535, image embedding prior 540, image generation model 545, and synthetic image 550.

Text prompt 500 is an example of, or includes aspects of, the corresponding element described with reference to FIGS. 1 and 14. Tokenizer 505 is an example of, or includes aspects of, the corresponding element described with reference to FIG. 10. Sparsity input 510 is an example of, or includes aspects of, the corresponding element described with reference to FIGS. 1 and 14. Sparsity token mapping 515 is an example of, or includes aspects of, the corresponding element described with reference to FIG. 10.

Combined text and sparsity tokens 520 is an example of, or includes aspects of, the corresponding element described with reference to FIG. 10. Text encoder 525 is an example of, or includes aspects of, the corresponding element described with reference to FIGS. 2 and 10. Text embedding 530 is an example of, or includes aspects of, the corresponding element described with reference to FIG. 10.

Image generation prior model 535 is an example of, or includes aspects of, the corresponding element described with reference to FIGS. 2 and 10. Image generation model 545 is an example of, or includes aspects of, the corresponding element described with reference to FIGS. 2 and 14.

In this example, the system obtains text prompt 500 and sparsity input 510. For example, a user may provide both inputs via a user interface as described with reference to FIG. 1. The text prompt 500 is passed into a tokenizer to obtain a sequence of tokens. In machine learning, “tokens” refer to the smallest meaningful units of text, such as words or subwords. In this context, tokens are represented by token identifiers, which are typically integer-type values corresponding to the words or subwords in a predefined vocabulary. These token identifiers are distinct from token embeddings, which are the richer, learned representations of the tokens used during the model's processing.

Similarly, the sparsity input 510 is tokenized by a sparsity token mapping 515 operation to look up a nonce token corresponding to the sparsity input. In some examples, the sparsity input 510 is one of three possible values, and sparsity token mapping 515 looks up the corresponding nonce token for the input value. Embodiments are not necessarily limited thereto, however, and other embodiments may have tokens corresponding to fewer or more than three sparsity values.

The text tokens and the sparsity token are combined to obtain combined text and sparsity tokens 520, which are input to text encoder 525 to obtain text embedding 530. The text encoder 525 may, for example, obtain initial token embeddings and perform an attention process on the sequence of token embeddings to obtain the final text embedding 530. The text embedding 530 is then input into image generation prior model 535.

Embodiments of image generation prior model 535 include a diffusion-based model that is trained to translate an input text embedding to generate an image embedding in a multi-modal space, such as the CLIP space. The image generation prior model 535 may perform this generation by approximating a reverse diffusion process as described with reference to FIG. 3. The generated image embedding, also referred to as a “prior embedding” or image embedding prior 540, encodes a visual representation of both the image element described in the input text prompt 500 and the sparsity level from sparsity input 510. By incorporating the sparsity information, the image embedding captures not only the content of the text but also the desired pattern density. This image embedding is applied to layers of image generation model 545 to condition its generation and generate synthetic image 550, which depicts a pattern of the image element at the desired sparsity level.

In some embodiments, image generation model 545 includes multiple generation U-Net networks. This approach is called the “mixture of experts” approach and is sometimes used to disentangle the expertise of different networks. For example, a first network may be trained to be adept at obtaining a depiction of a single instance of the image element, and the second network may be trained to generate a pattern of the image element using the first network's output as conditioning. In some embodiments, the image embedding prior 540 is applied to a select set of decoder layers of the U-Net(s).

### Generating Pattern Images

FIG. 6 shows a diffusion process 600 according to aspects of the present disclosure. In some examples, diffusion process 600 describes an operation of the image generation prior model 210 or the image generation model 215 described with reference to FIG. 2, such as the reverse diffusion process 340 of guided diffusion model 300 described with reference to FIG. 3.

As described above with reference to FIG. 3, using a diffusion model can involve both a forward diffusion process 605 for adding noise to an image (or features in a latent space) and a reverse diffusion process 610 for denoising the images (or features) to obtain a denoised image. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate images with successively greater noise, and a neural network is trained to perform the reverse diffusion process 610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy image 615 and denoises the data to obtain the p(xₜ₋₁|xₜ). At each step t−1, the reverse diffusion process 610 takes xₜ, such as first intermediate image 620, and t as input. Here, t represents a step in the sequence of transitions associated with different noise levels. The reverse diffusion process 610 outputs xₜ₋₁, such as second intermediate image 625 iteratively until x_{T} reverts back to x₀, the original image 630. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T};0,1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

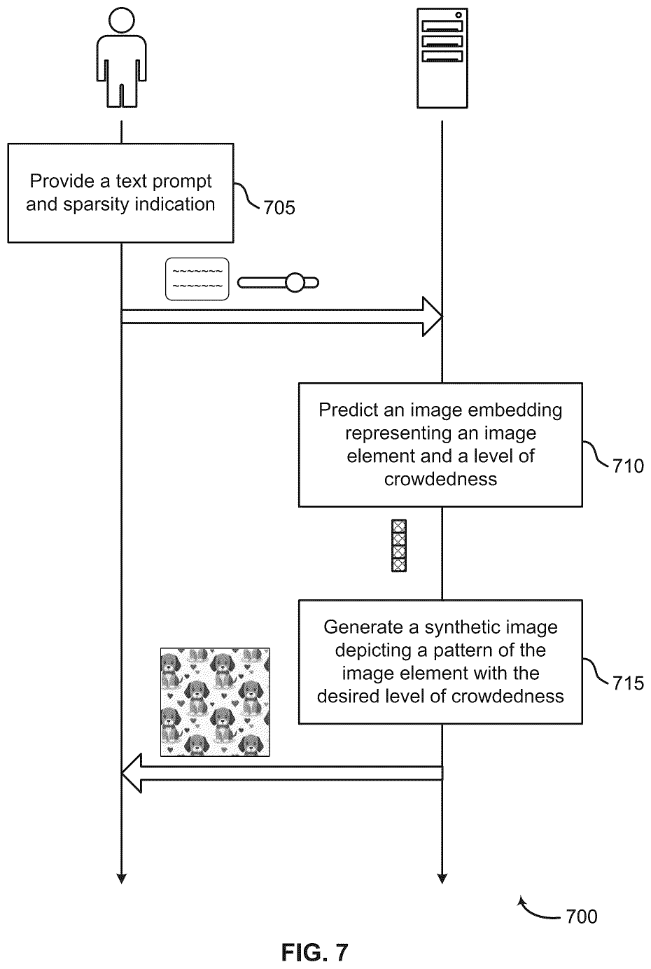

FIG. 7 shows an example of a method 700 for providing a pattern image with a desired level of crowdedness to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, a user provides a text prompt and a sparsity indication. The user may do so via a user interface as described with reference to FIG. 1. The text prompt may include an image element, and the sparsity indication indicates the desired level of crowdedness in a generated image depicting a pattern of the image element. The sparsity indication may be obtained by interacting with a GUI element such as a slider or a list of available sparsity settings.

At operation 710, the system predicts an image embedding representing an image element and a level of crowdedness. An image generation prior model may process the text and sparsity inputs to generate the image embedding. For example, the image generation prior model may perform a reverse diffusion process that translates a text embedding that represents a point in a multi-modal space into an image embedding that represents another point in the same multi-modal space, but within an image “cluster” of the space that better encodes visual characteristics.

At operation 715, the system generates a synthetic image depicting a pattern of the image element with the desired level of crowdedness. For example, an image generation model may perform a reverse diffusion process that is conditioned by the image embedding to obtain the synthetic image. Additional detail regarding the reverse diffusion process is described with reference to FIGS. 3-4 and 6.

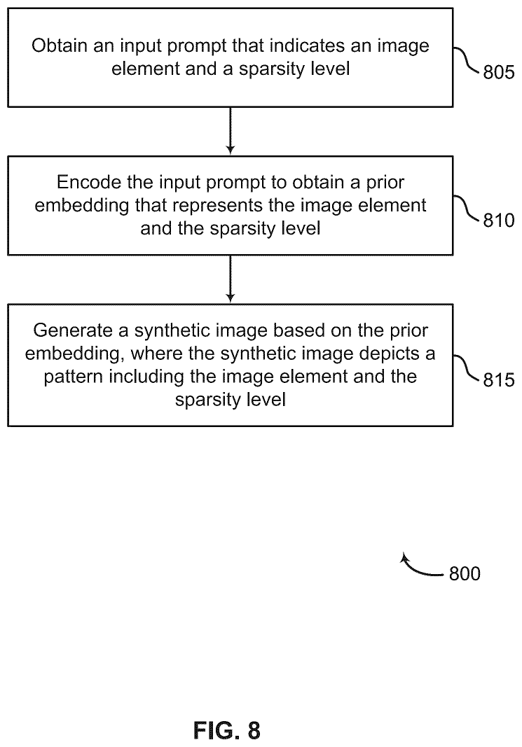

FIG. 8 shows an example of a method 800 for generating a pattern image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains an input prompt that indicates an image element and a sparsity level. In some cases, the operations of this step refer to, or may be performed by, a pattern generation apparatus as described with reference to FIGS. 1 and 2. A user may type out an input prompt and select a sparsity level via a user interface as described with reference to FIG. 1.

At operation 810, the system encodes the input prompt to obtain a prior embedding that represents the image element and the sparsity level. In some cases, the operations of this step refer to, or may be performed by, an image generation prior model as described with reference to FIGS. 2, 5, and 10. The image generation prior model is trained to generate the image embedding in a multimodal space, aligning the textual and visual representations. This training process involves optimizing the model to predict an image embedding—referred to as a “prior embedding”—from a text embedding that includes both the input prompt and the sparsity token. The prior embedding encodes the visual content described by the input text as well as the level of sparsity.

At operation 815, the system generates a synthetic image based on the prior embedding, where the synthetic image depicts a pattern including the image element and the sparsity level. In some cases, the operations of this step refer to, or may be performed by, an image generation model as described with reference to FIGS. 2, 5, and 14. The image generation model performs a reverse diffusion process that is conditioned on the prior embedding. For example, the image generation model may incorporate the features from the prior embedding using a cross-attention process, in which the current sample and the prior embedding are each split into smaller units, such as tokens or patches. These units can then reference each other through attention layers, allowing the model to refine the synthetic image by aligning features from the prior embedding with corresponding parts of the image being generated, thereby ensuring the synthetic image depicts both the described image element and the specified sparsity level.

Accordingly, in some examples training an image generation model includes obtaining training data including an image and a training prompt that indicates an image element; classifying the image using a sparsity classifier to obtain a sparsity level; generating a predicted prior embedding based on the training prompt and the sparsity level; and training, using the training data, an image generation prior model to generate a prior embedding that represents the image element and a pattern with the sparsity level

FIG. 9 shows an example of a training data preparation pipeline according to aspects of the present disclosure. The example shown includes preliminary set of images 900, aesthetic classifier 905, filtered set of images 910, sparsity classifier 915, and filtered and classified images 920. The preliminary set of images 900 represents a collection of diverse image samples that may vary in quality, composition, and overall aesthetic appeal. Before these images can be used for training, they are processed through several stages to ensure that only high-quality images, categorized by sparsity level, are included in the final dataset.

Aesthetic classifier 905 is an example of, or includes aspects of, the corresponding element described with reference to FIG. 2. Sparsity classifier 915 is an example of, or includes aspects of, the corresponding element described with reference to FIGS. 2 and 10.

In this example, the system inputs the preliminary set of images 900 through aesthetic classifier 905, which computes an aesthetic score for each image. The aesthetic classifier is trained to recognize visually appealing features, such as balance, clarity, color harmony, and other design principles. Based on the scores generated, the classifier filters out any images that do not meet a certain aesthetic threshold, resulting in the filtered set of images 910. These images are more likely to be high-quality and suitable for pattern generation tasks, improving the performance of the overall system by focusing only on desirable image content. In some examples, the aesthetic classifier 905 generates higher scores for images that have vectorizable attributes, so the created dataset includes images that are mostly of the vector-style as described above.

The sparsity classifier 915 is trained in a prior phase to classify an image into a sparsity class based on the arrangement and density of its visual elements. After the filtered images pass through the aesthetic classifier, they are input into the sparsity classifier 915, which assigns each image into one of three sparsity classes: “sparse,” “medium,” or “dense.” These classes are based on how closely packed or widely spaced the elements of the image are. For example, sparse images 925 contain fewer elements that are widely spaced, while dense images 935 include a greater number of elements arranged in close proximity. Medium images 930 fall somewhere between the two levels of sparsity. The filtered and classified images 920, now organized by their aesthetic quality and sparsity level, can be used in subsequent steps to train the image generation model to better capture the desired pattern density.

FIG. 10 shows an example of an image generation prior model training pipeline according to aspects of the present disclosure. The example shown includes training data 1000, sparsity classifier 1005, one-hot vector sparsity classification 1010, sparsity token mapping 1015, training caption 1020, tokenizer 1025, combined text and sparsity tokens 1030, text encoder 1035, text embedding 1040, image generation prior model 1045, predicted image embedding 1050, training component 1055, image encoder 1060, and ground-truth image embedding 1065.

Sparsity classifier 1005 is an example of, or includes aspects of, the corresponding element described with reference to FIGS. 2 and 9. Sparsity token mapping 1015 is an example of, or includes aspects of, the corresponding element described with reference to FIG. 5. Tokenizer 1025 is an example of, or includes aspects of, the corresponding element described with reference to FIG. 5. Combined text and sparsity tokens 1030 is an example of, or includes aspects of, the corresponding element described with reference to FIG. 5.

Text encoder 1035 is an example of, or includes aspects of, the corresponding element described with reference to FIGS. 2 and 5. Text embedding 1040 is an example of, or includes aspects of, the corresponding element described with reference to FIG. 5. Image generation prior model 1045 is an example of, or includes aspects of, the corresponding element described with reference to FIGS. 2 and 5. Training component 1055 is an example of, or includes aspects of, the corresponding element described with reference to FIGS. 2 and 14. Image encoder 1060 is an example of, or includes aspects of, the corresponding element described with reference to FIG. 2.

In this example, training data 1000 including training images and their captions are used to train an image generation prior model 1045 to generate image embeddings (also referred to as “prior embeddings”) that encode a representation of both an image element described in the caption as well as the sparsity level of the image as determined by a trained sparsity classifier. First, a training image is input to sparsity classifier 1005 to obtain a one-hot vector sparsity classification 1010 of the training image that indicates the training images' level of sparsity. The one-hot vector sparsity classification 1010 is translated using a sparsity token mapping operation 1015 to obtain a sparsity token. The caption of the training image is input to tokenizer 1025 which generates a sequence of text tokens. These are combined with the sparsity token to obtain combined text and sparsity tokens 1030.

Text encoder 1035 processes combined text and sparsity tokens 1030 to generate text embedding 1040, which is then input to image generation prior model 1045. Image generation prior model 1045 uses text embedding 1040 as conditioning during a reverse diffusion process to generate predicted image embedding 1050. Meanwhile, the same training image is input to a pretrained image encoder, e.g. image encoder 1060, to obtain a ground-truth image embedding 1065. The image encoder may be configured to obtain image features in, for example, the CLIP space. In some embodiments, the image encoder 1060 is indeed an instance of the pretrained CLIP image encoder.

The training component 1055 then computes a cosine similarity loss between the predicted image embedding 1050 and the ground-truth image embedding 1065, which quantifies the differences between the two tensors. The cosine similarity loss is backpropagated through image generation prior model 1045 to train its parameters to generate more accurate prior embeddings. In some embodiments, the backpropagation of the loss is further used to adjust initial embeddings of the sparsity tokens, thereby shaping their definitions for later use. In this way, embodiments learn to generate prior embeddings that accurately reflect both the image content described in the caption and the corresponding sparsity level, enabling the generation of images that faithfully depict the image element in a pattern that has the desired pattern density.

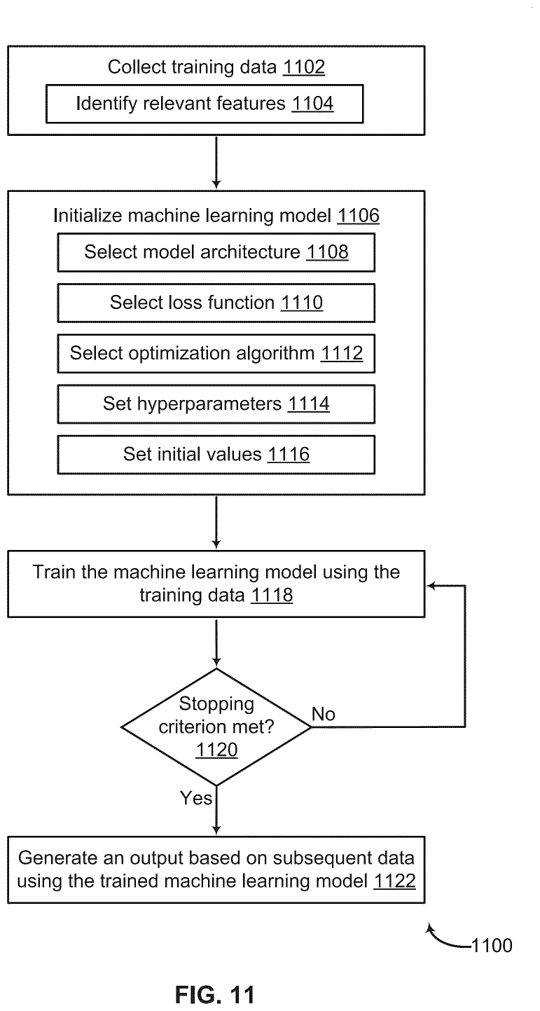

FIG. 11 is a flow diagram depicting an algorithm as a step-by-step procedure 1100 in an example implementation of operations performable for training a machine-learning model. In some embodiments, the procedure 1100 describes an operation of the training component 240 described for configuring image generation prior model 210 and the image generation model 215 described with reference to FIG. 2. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

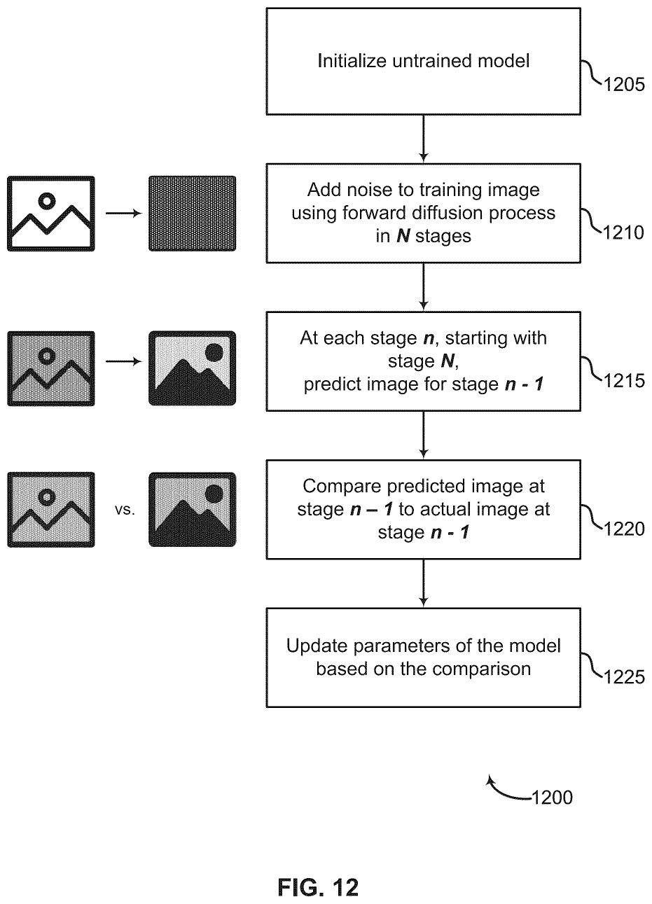

FIG. 12 shows an example of a method 1200 for training a diffusion model according to aspects of the present disclosure. In some embodiments, the method 1200 describes an operation of the training component 240 described for configuring image generation prior model 210 and the image generation model 215 described with reference to FIG. 2. The method 1200 represents an example for training a reverse diffusion process as described above with reference to FIG. 6. In some examples, these operations are performed by a system including a processor executing a set of codes to control functional elements of an apparatus, such as the guided diffusion model described in FIG. 3.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1215, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1220, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

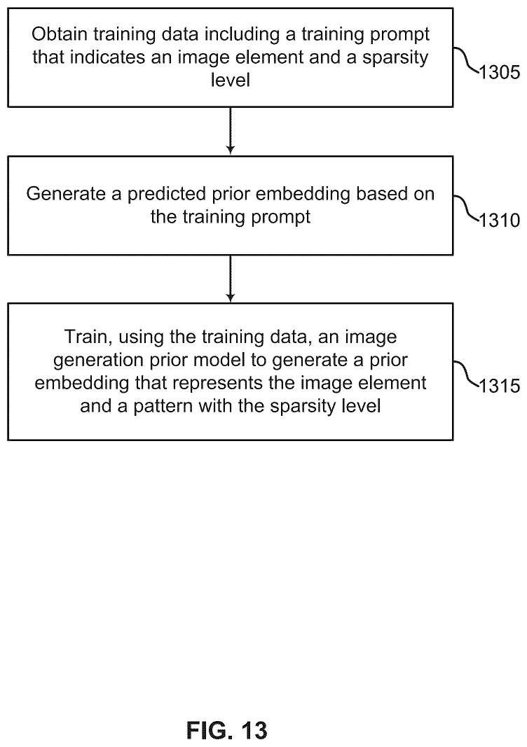

FIG. 13 shows an example of a method 1300 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system obtains training data including a training prompt that indicates an image element and a sparsity level. In some cases, the operations of this step refer to, or may be performed by, a pattern generation apparatus as described with reference to FIGS. 1 and 2. In some embodiments, the training prompt includes only the image element, and the sparsity level is determined via a trained sparsity classifier as described in the pipeline with reference to FIG. 10.

At operation 1310, the system generates a predicted prior embedding based on the training prompt. In some cases, the operations of this step refer to, or may be performed by, an image generation prior model as described with reference to FIGS. 2, 5, and 10. For example, the image generation prior model may utilize a text embedding that encodes the inputs from the training prompt as conditioning for a generative reverse diffusion process to obtain the predicted prior embedding.

At operation 1315, the system trains, using the training data, an image generation prior model to generate a prior embedding that represents the image element and a pattern with the sparsity level. In some cases, the operations of this step refer to, or may be performed by, a training component as described with reference to FIGS. 2, 10, and 14. Additional detail regarding the training process is provided with reference to FIG. 10.

FIG. 14 shows an example of a training pipeline for learning color conditioning according to aspects of the present disclosure. The example shown includes text prompt 1400, sparsity input 1405, color palette input 1410, image generation model 1415, latent color palette decoder 1420, extracted color palette 1425, and training component 1430.

Text prompt 1400 is an example of, or includes aspects of, the corresponding element described with reference to FIGS. 1 and 5. Sparsity input 1405 is an example of, or includes aspects of, the corresponding element described with reference to FIGS. 1 and 5. Image generation model 1415 is an example of, or includes aspects of, the corresponding element described with reference to FIGS. 2 and 5. Training component 1430 is an example of, or includes aspects of, the corresponding element described with reference to FIGS. 2 and 10.

Embodiments of the present disclosure further include a training process specifically designed to enable the image generation model to incorporate color palette conditions during the generation of images. In this process, the text prompt 1400, sparsity input 1405, and color palette input 1410 are provided as conditioning inputs to image generation model 1415. These inputs guide the model in generating an image that not only aligns with the textual description and pattern density but also adheres to the color palette specified by the user. The image generation model 1415 operates by predicting and removing noise from the latent image representation during each iteration of the reverse diffusion process. The image generation model 1415 is trained to consider the color palette condition during this denoising process by periodically checking that the latent code representing the generated image accurately reflects the desired color scheme.

Embodiments include a latent color palette decoder 1420 that is designed to extract the current color palette from the intermediate latent sample at any stage of the generative process. This decoder allows the system to assess whether the colors present in the latent sample are aligning with the input color palette without fully decoding the latent sample into a pixel image. This approach is computationally efficient, as it bypasses the need for resource-intensive decoding operations that would otherwise be required to obtain the pixel-level image data before extracting the color palette. The extracted color palette 1425 from the latent sample is then compared to the input color palette 1410 to assess the similarity between the two.

During training, the training component 1430 computes an L1 loss between the extracted color palette 1425 and the input color palette 1410. The L1 loss quantifies the difference between the two color palettes, focusing on the pixel-wise differences in color intensity. Once this loss is computed, it is backpropagated through the layers of image generation model 1415. This allows the model to adjust its parameters so that it can better incorporate the color palette condition during subsequent iterations of training. As the model learns, it becomes increasingly proficient at generating images that not only match the textual description and sparsity condition but also reflect the input color palette with high fidelity.

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, a pattern generation apparatus as described in FIGS. 1 and 2. In some embodiments, computing device 1500 includes one or more processors 1505 are configured to execute instructions stored in memory subsystem 1510 to obtain an input prompt that indicates an image element and a sparsity level; encode, using an image generation prior model, the input prompt to obtain a prior embedding that represents the image element and the sparsity level; and generate, using an image generation model, a synthetic image based on the prior embedding, wherein the synthetic image depicts a pattern including the image element and the sparsity level.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

Accordingly, the present disclosure includes the following aspects.

A method for pattern image generation is described. One or more aspects of the method include obtaining an input prompt that indicates an image element and a sparsity level; encoding, using an image generation prior model, the input prompt to obtain a prior embedding that represents the image element and the sparsity level; and generating, using an image generation model, a synthetic image based on the prior embedding, wherein the synthetic image depicts a pattern including the image element and the sparsity level.

Some examples of the method, apparatus, non-transitory computer readable medium, and system further include obtaining a content prompt and a sparsity indicator. Some examples further include identifying a sparsity token based on the sparsity indicator. Some examples further include combining the content prompt with the sparsity token to obtain the input prompt. In some aspects, the input prompt comprises a sequence of text tokens; and the prior embedding comprises a representation of the input prompt in an image embedding space. In some aspects, the prior embedding encodes the pattern.

Some examples of the method, apparatus, non-transitory computer readable medium, and system further include obtaining a color input indicating one or more colors, wherein the synthetic image is generated based on the color input to include the one or more colors. Some examples of the method, apparatus, non-transitory computer readable medium, and system further include obtaining a noise input. Some examples further include denoising the noise input based on the prior embedding to obtain the synthetic image. In some aspects, the image generation model is trained using training data including a training prompt that indicates the sparsity level.

A method for pattern image generation is described. One or more aspects of the method include obtaining training data including a training prompt that indicates an image element and a sparsity level; generating a predicted prior embedding based on the training prompt; and training, using the training data, an image generation prior model to generate a prior embedding that represents the image element and a pattern with the sparsity level.

Some examples of the method, apparatus, non-transitory computer readable medium, and system further include obtaining an image. Some examples further include classifying the image to obtain the sparsity level. In some aspects, the training prompt comprises a nonce token indicating the sparsity level. Some examples of the method, apparatus, non-transitory computer readable medium, and system further include encoding an image corresponding to the training prompt to obtain an image embedding. Some examples further include computing a similarity between the predicted prior embedding and the image embedding. Some examples further include updating parameters of the image generation prior model based on the similarity. Some examples of the method, apparatus, non-transitory computer readable medium, and system further include obtaining a preliminary set of images. Some examples further include filtering the preliminary set of images based on an aesthetic classifier to obtain a filtered set of images, wherein the training prompt describes an image from the filtered set of images.

An apparatus for pattern image generation is described. One or more aspects of the apparatus include at least one processor; at least one memory storing instructions executable by the at least one processor; an image generation prior model storing parameters in the at least one memory and trained to encode an input prompt to obtain a prior embedding that represents an image element and a sparsity level; and an image generation model storing parameters in the at least one memory configured to generate a synthetic image based on the prior embedding, wherein the synthetic image depicts a pattern including the image element and the sparsity level.

Some examples of the apparatus, system, and method further include a text encoder configured to encode the input prompt to generate a text embedding. Some examples of the apparatus, system, and method further include an image encoder configured to encode a training image to generate an image embedding. Some examples further include a sparsity classifier configured to classify a training image to obtain the sparsity level. Some examples further include an aesthetic classifier configured to filter a preliminary set of training images.

In some aspects, the image generation model comprises a diffusion model. In some aspects, the image generation prior model comprises a diffusion model. Some examples of the apparatus, system, and method further include a color extractor configured to decode an output from the image generation model to obtain a color palette.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt that indicates an image element and a sparsity level;
encoding, using an image generation prior model, the input prompt to obtain a prior embedding that represents the image element and the sparsity level; and
generating, using an image generation model, a synthetic image based on the prior embedding, wherein the synthetic image depicts a pattern including the image element and the sparsity level.

2. The method of claim 1, wherein obtaining the input prompt comprises:
obtaining a content prompt and a sparsity indicator;
identifying a sparsity token based on the sparsity indicator; and
combining the content prompt with the sparsity token to obtain the input prompt.

3. The method of claim 1, wherein:
the input prompt comprises a sequence of text tokens; and the prior embedding comprises a representation of the input prompt in an image embedding space.

4. The method of claim 1, wherein:
the prior embedding encodes the pattern.

5. The method of claim 1, further comprising:
obtaining a color input indicating one or more colors, wherein the synthetic image is generated based on the color input to include the one or more colors.

6. The method of claim 1, wherein generating the synthetic image comprises:
obtaining a noise input; and
denoising the noise input based on the prior embedding to obtain the synthetic image.

7. The method of claim 1, wherein:
the image generation model is trained using training data including a training prompt that indicates the sparsity level.

8. A method of training a machine learning model, the method comprising:
obtaining training data including an image and a training prompt that indicates an image element;
classifying the image using a sparsity classifier to obtain a sparsity level;
generating a predicted prior embedding based on the training prompt and the sparsity level; and
training, using the training data, an image generation prior model to generate a prior embedding that represents the image element and a pattern with the sparsity level.

9. The method of claim 8, wherein:
the sparsity classifier is trained to generate the sparsity level using sparsity training data including a sparsity annotation.

10. The method of claim 8, wherein:
the training prompt comprises a nonce token indicating the sparsity level.

11. The method of claim 8, wherein training the image generation prior model comprises:
encoding an image corresponding to the training prompt to obtain an image embedding;
computing a similarity between the predicted prior embedding and the image embedding; and
updating parameters of the image generation prior model based on the similarity.

12. The method of claim 8, wherein obtaining the training data comprises:
obtaining a preliminary set of images; and
filtering the preliminary set of images based on an aesthetic classifier to obtain a filtered set of images, wherein the training prompt describes an image from the filtered set of images.

13. An apparatus comprising:
at least one processor;
at least one memory storing instructions executable by the at least one processor;
an image generation prior model storing parameters in the at least one memory and trained to encode an input prompt to obtain a prior embedding that represents an image element and a sparsity level; and
an image generation model storing parameters in the at least one memory and configured to generate a synthetic image based on the prior embedding, wherein the synthetic image depicts a pattern including the image element and the sparsity level.

14. The apparatus of claim 13, further comprising:
a text encoder configured to encode the input prompt to generate a text embedding.

15. The apparatus of claim 13, further comprising:
an image encoder configured to encode a training image to generate an image embedding.

16. The apparatus of claim 13, further comprising:
a sparsity classifier configured to classify a training image to obtain the sparsity level.

17. The apparatus of claim 13, further comprising:
an aesthetic classifier configured to filter a preliminary set of training images.

18. The apparatus of claim 13, wherein:
the image generation model comprises a diffusion model.

19. The apparatus of claim 13, wherein:
the image generation prior model comprises a diffusion model.

20. The apparatus of claim 13, further comprising:
a color extractor configured to decode an output from the image generation model to obtain a color palette.
